(19) United States
(12) Patent Application Publication
(10) Pub. No.: US 2014/0041383 A1
(43) Pub. Date: Feb. 13, 2014

(54) PRESSURE GENERATING DEVICE

(71) Applicants: Helmut Hauck, Euerbach (DE); Thomas Heege, Sennfeld (DE); Hubert Herbst, Gadheim (DE); Sandra Kamm, Gochsheim (DE)

(72) Inventors: Helmut Hauck, Euerbach (DE); Thomas Heege, Sennfeld (DE); Hubert Herbst, Gadheim (DE); Sandra Kamm, Gochsheim (DE)

(21) Appl. No.: 14/002,764

(22) PCT Filed: Mar. 1, 2012
(86) PCT No.: PCT/EP2012/053503

§ 371 Date: Oct. 29, 2013

(30) Foreign Application Priority Data
Mar. 2, 2011 (DE) 10 2011 004 975.4

(51) Int. Cl. F02B 39/00; F16C 19/54

(52) U.S. Cl. CPC F02B 39/00; F16C 19/54
USPC 60/605.1

(57) ABSTRACT

A pressure generating device (1), such as a boost pressure generator of an internal combustion engine, includes a housing (2), in which a rotor (3) is axially and radially supported by a bearing assembly (5). A gap (4) extends in the radial direction (4) between the housing (2) and the rotor (3) at at least one axial position of the rotor (3). In order to ensure a minimal and constant gap between the housing and the rotor, an axial bearing (5′) is provided exclusively for supporting axial forces.

The invention relates to a pressure generating device, in particular to a boost pressure generator of an internal combustion engine, which includes a housing, in which a rotor is rotatably disposed, wherein a gap extending in the radial direction (i.e. axial) is formed between the housing and the rotor at at least one axial position of the rotor, wherein the rotor is axially and radially supported in the housing by a bearing assembly.

A pressure generating device of this type is for example known from DE 20 2004 017 194 U1. Here, the shaft of an exhaust gas turbocharger is guided in two angular contact ball bearings, which are spring-loaded against each other and thus hold the shaft with a defined preload.

Systems of the above-described type for turbocharging an internal combustion engine are mostly based on rotating elements which are usually rotatably supported by a rolling-element bearing arrangement in a housing. This is true in particular for the so-called gas-dynamic pressure wave chargers, which are a preferred application of the present invention. These chargers have at least two regions in which different pressures prevail; such chargers thus have at least one low-pressure region and one high-pressure region. The central component of such a charger is the rotor, which is required, among other things, for the pressure increase and for the separation of the two pressure regions. The rotor is radially and axially supported in a bearing assembly in a housing. In order to ensure the function of the pressure-space separation, the gap between the housing and the rotor is on the one hand small, and on the other hand is held constant during operation.

In this context it has thus been found to be problematic that the setting and maintaining of a precise axial gap between housing and rotor is difficult.

Known systems include a combined radial-axial bearing assembly, which consists of at least two bearing rows which must be adjusted in order to eliminate a mechanically-induced axial clearance of the bearing assembly. Furthermore, the bearing must be mounted with additional fitting washers in order to be able to eliminate axial component tolerances. Finally, a clamping nut is usually also required, in order to avoid, under load, co-rotating bearing rings, which can occur due to a different thermal expansion of the components.

Accordingly, a great effort is needed to ensure a minimal and constant gap between the rotor and the housing, which requires correspondingly high manufacturing- and installation costs. Due to the multiple installation steps required, there are also many possibilities for error. These possibilities for error can lead to premature damage to the bearing and can negatively influence the gap between the rotor and the housing.

The object of the invention is to further develop a pressure generating device of the above-mentioned type such that the disadvantages mentioned can be prevented. Accordingly, an economical solution is provided for the manufacturing of a pressure generating device of the above-mentioned type, wherein it is possible to set and maintain a smallest-possible gap between the rotor and the housing in a simpler way than previously.

The solution of this object by the invention is characterized in that the bearing assembly includes an axial bearing formed exclusively for supporting axial forces.

In this case, the axial bearing is preferably disposed near the gap. The radially-extending (i.e. the axial) gap delimits a high-pressure region of the pressure generating device from the region of the rotor.

The axial bearing is preferably formed as a rolling-element bearing.

At least one raceway for the rolling elements of the axial bearing can be machine-cut directly into the housing and/or in the rotor.

In the alternative, it is also possible that parts of the bearing are integrated into an adjacent component using known connection techniques (e.g. materially-bonded by adhesion or soldering, interference-fit), wherein this component then preferably forms a preassembled (partially assembled) unit with the adjacent component.

Furthermore, the bearing assembly usually includes at least one, preferably two axially spaced-apart bearing(s) for supporting of radial forces, which is or are operatively disposed between the housing and the rotor. The at least one or the two axially spaced bearing(s) is or are preferably formed as (a) rolling-element bearing(s), in particular as a deep-groove ball bearing and as a roller bearing.

A further development provides that a spring element is operatively disposed between the housing and the rotor, which spring element exerts a preload force on the axial bearing. The spring element can be formed as a clamping ring or as a compression spring.

The bearings of the bearing assembly embodied as rolling-element bearings can include bearing elements, in particular rolling elements, made from ceramic material.

The housing is preferably made from cast metal, in particular from light metal. In this respect, for example, cast steel can thus be used. A manufacturing of the housing from a metal plate is also possible. Furthermore, plastic is also advantageous as a material for the housing; a variant provides for the use of plastic-metal hybrids.

The pressure generating device is preferably a boost pressure generator of an internal combustion engine, wherein the boost pressure generator is an exhaust gas turbocharger, a mechanical charger or a gas-dynamic pressure wave charger.

It is also possible that a spring-loaded bearing assembly is provided adjacent to the axial bearing for the combined axial and radial supporting of the rotor in the housing.

The bearing assembly is preferably formed sealed, and indeed both axially as well as radially. In this case, the bearing assembly can be grease-lubricated. Relubrication possibilities can further be provided. In this case, a preferred design provides that intermediate elements, which form lubricating grease reservoirs, are provided between the bearing points of the bearing assembly. The intermediate elements serve to hold lubricant in the region of the bearing points. These intermediate elements can also be formed to fix bearings or bearing parts.

The bearing arrangement can also optionally include one-part outer rings for two bearing points. Correspondingly, one-part inner rings can also be provided for two bearing points. It can also be provided that one or more raceways is machine-cut directly into the outer circumference of the rotor to be supported; a separate bearing ring is then omitted accordingly.

In this case, at least two parts of the entire bearing assembly can be connected to one another such that they form a preassembled unit. The assembly process can be further simplified thereby. It has already been mentioned above that parts of the bearing assembly can be integrated into adjacent components (such as e.g. housing or rotor).

The preferred charger types, in which the invention is used, are the exhaust gas turbocharger, the mechanical charger (compressor) or the gas-dynamic pressure wave charger. The chargers are preferably used in internal combustion engines of automobiles. However, the proposed chargers are generally also suitable in all applications for pressure increase in which two different pressure regions are present, and a rotor forms the (axial) separation gap between the regions, and thus the minimization and constancy of the separation gap is of great importance.

To provide a cost-effective possibility to set and maintain the radially-extending (i.e. the axial) gap between the housing and the rotor to a minimal value—in particular between the rotor and a fixed high-pressure region of a pressure wave bearing for an automobile engine—the invention thus provides that the bearing assembly for the rotor can undertake the function of the gap minimization and the holding-constant of the gap via its highly precise manufacture, wherein the combined load, which acts on the rotor, is divided into a radial component and an axial component, and each component is individually supported by a corresponding bearing. In this case, the axial load in particular is supported by a pure axial bearing, by which the gap between the rotor and the housing can be precisely set and/or maintained.

A further advantage of the proposed solution is that mixed friction can be avoided, since the axial and the radial supporting are effected separately. The friction can be generally reduced thereby. The service life increases accordingly, and the temperature development is lower. Furthermore, the tendency for excitation of vibrations is reduced, i.e. the operating noise is lower.

It is advantageous that the installation steps of the spring-loading of the bearing and the fitting washer installation can be eliminated in this manner. An axial fixing by a clamping nut can additionally undertake the tolerance compensation and the axial clearance elimination.

Accordingly, the installation process is faster, simpler, and more reliable, wherein corresponding economic advantages also arise. The function of the charger is also more reliable and the failure risk is thus minimized.

The gap between the rotor and the housing is determined only by the narrow bearing tolerances of the axial bearing, and can thereby be minimized Furthermore, the axial bearing undertakes the holding-constant of the axial gap between the housing and the rotor.

The separation between the pressure regions of the charger is improved by the reduction of the gap in its size, whereby the performance of the charger and its degree of efficiency can be improved. The latter also leads to a wider field of application of the charger.

The proposed solution is provided in particular for a charger for internal combustion engines. It is, however, also suitable for all applications in which a pressure increase of a medium is the operating principle.

Exemplary embodiments of the invention are shown in the drawings.

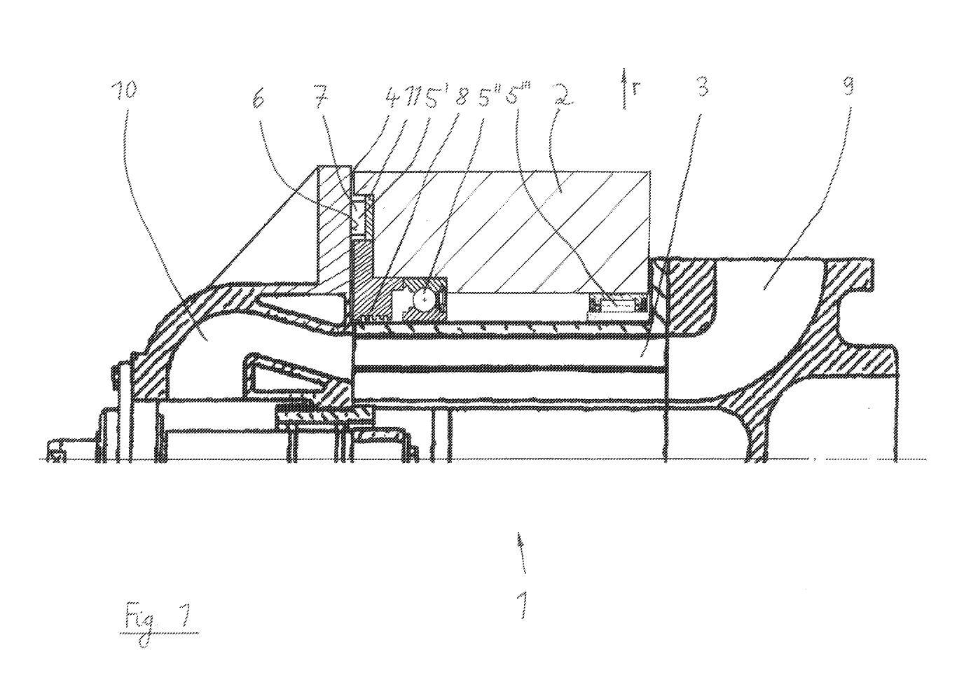

FIG. 1 shows the radial section through a pressure generating device in the form of a pressure wave charger according to a first embodiment of the invention and

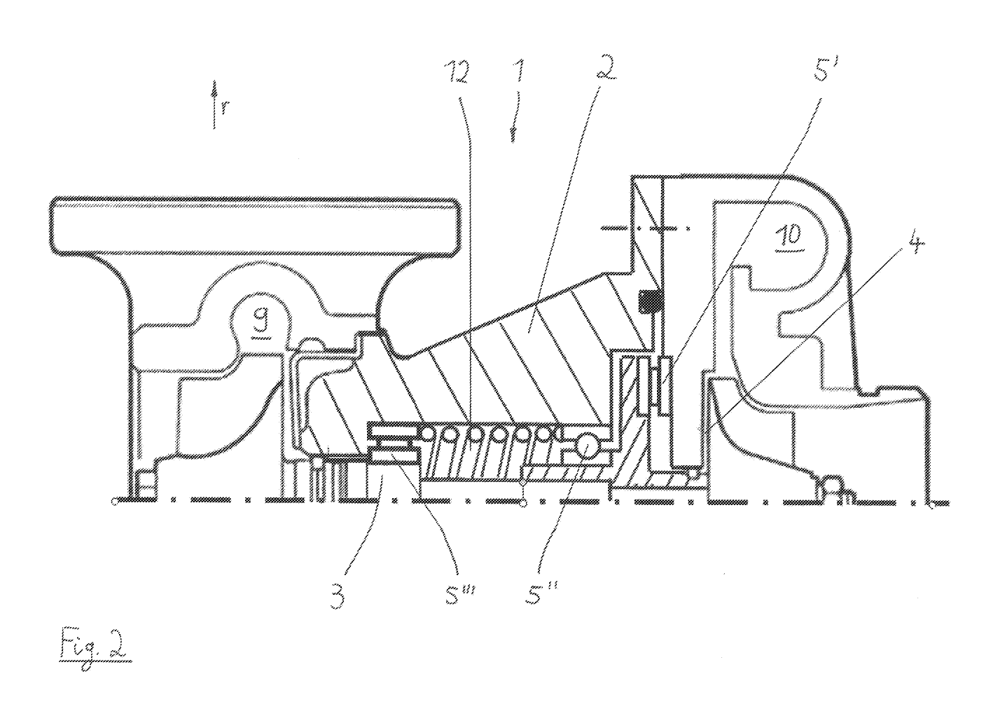

FIG. 2 shows the radial section through a pressure generating device in the form of a turbocharger according to a second embodiment of the invention.

A pressure generating device 1 formed as a pressure wave charger is shown in FIG. 1. The pressure generating device 1 includes a housing 2, in which a rotor 3 is rotatably disposed. The rotor 3 is supported here both radially and axially relative to the housing 2. A bearing assembly comprised of three bearings 5′, 5″, and 5′″ serves for this purpose.

The charger has a low-pressure region 9 and a high-pressure region 10. Gas from the low-pressure region 9 is compressed by the rotation of the rotor 3 and supplied to the high-pressure region 10.

An axial gap 4 is formed between an end side of the rotor 3 and the housing 2. For a high degree of efficiency of the pressure generating device 1, it is important that the axial gap be kept small on the one hand, but also remains constant during operation on the other hand.

The bearing assembly includes an axial bearing 5′, which is provided exclusively to set the axial position of the rotor 3 relative to the housing 2. In addition, in the exemplary embodiment the bearing assembly includes two bearings 5″ and 5′″, namely a deep groove ball bearing 5″ and a needle bearing 5′″.

It is important that the size of the axial gap 4 be determined by the axial bearing 5′, which is disposed near the gap 4 for this purpose. In the present case a groove is machine-cut into an end side of the housing 2; a bearing ring 11 of the axial bearing 5′ is inserted into the groove. The rolling elements 7 of the axial bearing 5′ abut on the bearing ring 11. The opposing raceway 6 of the axial bearing 5′ is directly formed by a section of the rotor 3.

A seal ring 8 is shown in FIG. 1 for sealing the charger.

A somewhat differently embodied solution of the pressure generating device 1 is illustrated in FIG. 2. In principle, the same applies as embodied in the context of FIG. 1.

An axial bearing 5′ is again operatively disposed between the rotor 3 and the housing 2 to hold the gap 4 to a small and constant value.

Another spring element 12 is to be mentioned in the exemplary embodiment according to FIG. 2—here in the form of a compression spring—which provides an axially-acting preload on the axial bearing 5′.

### REFERENCE NUMBER LIST

1 Pressure generating device
2 Housing
3 Rotor
4 Radially extending (axial) gap
5 Bearing assembly
5′ Axial bearing
5″ Deep groove ball bearing
5′″ Roller bearing/needle bearing
6 Raceway
7 Rolling elements
8 Seal ring
9 Low-pressure region
10 High-pressure region
11 Bearing ring
12 Spring element
r Radial direction

1-10. (canceled)

11. A pressure generating device comprising:
a housing,
a bearing assembly including an axial rolling-element bearing configured exclusively for supporting axial forces, and
a rotor axially and radially supported in the housing by the bearing assembly so as to be rotatable relative to the housing,
wherein a radially-extending gap is defined between the housing and the rotor at at least one axial position of the rotor, the axial rolling-element bearing being disposed adjacent to the gap.

12. The pressure generating device according to claim 11, wherein at least one raceway for rolling elements of the axial rolling-element bearing is machined directly into the housing and/or into the rotor.

13. The pressure generating device according to claim 11, wherein the bearing assembly further includes at least one bearing configured to support radial forces and operatively disposed between the housing and the rotor.

14. The pressure generating device according to claim 11, wherein the bearing assembly further includes at least two axially-spaced-apart bearings configured to support radial forces and operatively disposed between the housing and the rotor.

15. The pressure generating device according to claim 14, wherein the two axially-spaced-apart bearings are rolling-element bearings.

16. The pressure generating device according to claim 15, wherein the rolling-element bearings include rolling elements made from ceramic material.

17. The pressure generating device according to claim 11, further comprising a spring element operatively disposed between the housing and the rotor and exerting an axial preload force on the axial rolling-element bearing.

18. The pressure generating device according to claim 11, wherein the housing is comprised of cast metal or plastic.

19. The pressure generating device according to claim 11, wherein it is an exhaust gas turbocharger, a mechanical charger, or a gas-dynamic pressure wave charger of an internal combustion engine.

20. The pressure generating device according to claim 20, wherein rolling elements of the axial rolling-element bearing are cylindrical and the long axis of each of the cylindrical rolling elements extends in a radial direction relative to a rotating axis of the rotor.

21. The pressure generating device according to claim 20, wherein the bearing assembly further includes at least two axially-spaced-apart bearings configured to support radial forces and operatively disposed between the housing and the rotor.

22. The pressure generating device according to claim 21, wherein one of the two axially-spaced-apart bearings is a deep-groove ball bearing and the other of the two axially-spaced-apart bearings is a needle bearing.

23. The pressure generating device according to claim 22, wherein rolling elements are made from ceramic material.

24. The pressure generating device according to claim 23, further comprising a compression spring element operatively disposed between the two axially-spaced-apart bearings and exerting an axial preload force on the axial rolling-element bearing.

25. The pressure generating device according to claim 24, wherein the axial rolling-element bearing is disposed between surfaces of the rotor and the housing that define the radially-extending gap.

26. The pressure generating device according to claim 25, wherein the radially-extending gap delimits a high-pressure region of the pressure generating device from the rotor.

27. The pressure generating device according to claim 20, wherein rolling elements of the axial rolling-element bearing are rotatably disposed in a groove defined on an axial end side of the housing.

28. The pressure generating device according to claim 27, wherein the axial rolling-element bearing is disposed between surfaces of the rotor and the housing that define the radially-extending gap.

29. The pressure generating device according to claim 28, wherein the radially-extending gap delimits a high-pressure region of the pressure generating device from the rotor.

30. The pressure generating device according to claim 29, further comprising a bearing ring disposed in the groove defined on the axial end side of the housing and serving as a raceway for the rolling elements of the axial rolling-element bearing, and
wherein:
an opposing raceway for the rolling elements of the axial rolling-element bearing is defined directly on an axial end side of the rotor, and
a seal ring is disposed between the axial rolling-element bearing and the deep-groove ball bearing.
